(19) United States
(12) Patent Application Publication
(10) Pub. No.: US 2023/0410810 A1
(43) Pub. Date: Dec. 21, 2023

(54) METHODS AND APPARATUS FOR AUDIO ADJUSTMENT BASED ON VOCAL EFFORT

(71) Applicant: Intel Corporation, Santa Clara, CA (US)

(72) Inventors: Hector Alfonso Cordourier Maruri, Guadalajara (MX); Georg Stemmer, Munich (DE); Lukasz Kurylo, Gdansk (PL); Himanshu Bhalla, Bengaluru (IN)

(21) Appl. No.: 18/457,138

(22) Filed: Aug. 28, 2023

(51) Int. Cl. G10L 15/22; G10L 21/0208; G10L 21/013

(52) U.S. Cl. CPC G10L 15/22; G10L 21/0208; G10L 21/013; G10L 2015/227

(57) ABSTRACT

Methods and apparatus to audio adjustment based on vocal effort are disclosed herein. An example apparatus comprising interface circuitry, machine readable instructions, and programmable circuitry to at least one of instantiate or execute the machine readable instructions to identify speech with a soft voice type in audio from a first user device, the speech with the soft voice type including phonation, modify the audio to generate modified audio based on the identification of the speech with the soft voice type, and output the modified audio from a second user device.

### FIELD OF THE DISCLOSURE

This disclosure relates generally to audio analysis and, more particularly, to methods and apparatus to audio adjustment based on vocal effort.

### BACKGROUND

During human communication, people can use different vocal efforts (e.g., depending on the context, types of conversations, etc.). Normally, speakers use a regular voice type, but different environmental or emotional stressing conditions can cause a person to change to another voice type (concern of being overheard, having a heated argument, too much background noise, etc.). Speakers using soft voice types can be difficult to understand by listeners due to lower vocal amplitude and pitch, particularly during teleconferences.

### BRIEF DESCRIPTION OF THE DRAWINGS

FIG. 1 is a schematic illustration of an example audio adjustment system implemented in accordance with the teachings of this disclosure.

FIG. 2 is a block diagram of an example implementation of the audio adjuster circuitry of FIG. 1.

FIG. 3 is a visual representation of an example amplitude difference between normal vocal-effort speech and soft vocal-effort speech.

FIG. 4A is a graph of gain adjustment of a automatic gain control system.

FIG. 4B is a graph of a soft-vocal effort detection by the audio adjuster circuitry of FIGS. 1 and 2.

FIGS. 5 and 6 are flowcharts representative of example machine readable instructions and/or example operations that may be executed, instantiated, and/or performed by example programmable circuitry to implement the audio adjuster circuitry of FIG. 2.

FIG. 7 is a block diagram of an example processing platform including programmable circuitry structured to execute, instantiate, and/or perform the example machine readable instructions and/or perform the example operations of FIGS. 5 and 6 to implement the audio adjuster circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 5 and 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Systems, methods, apparatus, and articles of manufacture described herein provide substantially real-time audio adjustment based on an identified voice type in captured audio. As used herein, the term “voice type” refers to a characterization of a person's speech based on voice characteristics that result from the vocal effort exerted in generating that speech. As used herein, the terms “voice type” and “vocal effort classification” are used interchangeably. As used herein, the term “vocal effort” is a quantity that corresponds to a perceived amount of vocal loudness and strain used by a speaker. Speakers generally use greater vocal effort when trying to speak in environments with a large amount of ambient noise, when speaking to someone far away, when speaking to a large group of people, when in a state of great emotional investment, and/or when attempting to get one or more listener(s) attention. Speakers generally use comparatively less vocal effort when speaking to someone close by, when trying to conceal their speech from potential eavesdroppers, when trying not to disturb surrounding persons, when in environments with low amounts of ambient noise, and/or when the speaker is calm.

Examples disclosed herein refer to five different voice types, namely, in order of most vocal effort to least vocal effort, (1) the yelled voice type, (2) the loud voice type, (3) the regular voice type, (4) the soft voice type, and (5) the whispered voice type. It should be appreciated that vocal efforts can be divided into different numbers of classifications (e.g., regular, above-regular, and below-regular, etc.) as needed for analysis. However, a vocal classification system may include any number or types of voice types.

The example regular voice type corresponds to speech delivered with regular vocal effort. The regular voice type is characterized by speech produced during normal conversations, typically in the absence of environmental or emotional stressing conditions on the speaker. The regular voice type has normal amplitude and pitch. The yelled voice type (e.g., the shouted voice type, the yelled vocal effort classification, etc.) corresponds to speech delivered with a yelled voice type.

The example yelled voice type is characterized by speech produced at high amplitude and pitch. The yelled voice type is typically used by people who perceive a high level of ambient noise (e.g., background noise, etc.) and/or people in high states of emotional investment (e.g., a speaker is experiencing great joy, a speaker is experiencing great anger, a speaker is in pain, a speaker is surprised, etc.).

The example loud voice type (e.g., the loud vocal effort classification, etc.) corresponds to a speech delivered with a loud voice type. The loud voice type is characterized by speech produced with substantially higher amplitude and slightly higher pitch than the regular voice type and can be associated with the speaker perceiving high amounts of background noise (e.g., the Lombard effect, etc.). The loud voice type can also be associated with a speaker being heavily invested in the conversation content (e.g., responding to a funny story, speaking from a position of authority, speaking during a heated argument, etc.). The loud voice type has comparatively lower amplitude and pitch than the yelled voice type.

The example soft voice type corresponds to speech delivered with a soft voice type. The soft voice type is characterized by speech produced with phonation (e.g., pitch, tone, harmonic variation, etc.), but with clear speaker-intended lower amplitude and lower pitch than speech in the regular voice type. The soft voice type is generally used by people to prevent others from eavesdropping, to not disturb nearby persons, and/or speech said to calm a listener.

The example whispered voice type corresponds to speech delivered with a whispered voice type. Unlike the soft voice type, the whispered voice type is characterized by speech produced without phonation and very low amplitude (e.g., minimum loudness, etc.) The use of the whispered voice type by a speaker implies a strong desire to not disturb other nearby people and/or a desire not to be overheard by potential eavesdroppers.

In recent years, video and audio telecommunications have become more common due to an increase in workers working from home and the decentralization of office structures. Participants in virtual meetings in spaces with other people (e.g., a home with multiple people working, an open plan office, a coffee shop, etc.) often prefer to speak with reduced loudness due to concerns for privacy and/or disturbing others in the shared space. Many of these participants prefer to speak with a soft voice type (e.g., with a vocal effort with reduced amplitude and pitch, etc.) instead of whispered voice type (e.g., a vocal effort with reduced amplitude and no phonation, etc.). While speakers using a soft voice type reduce the likelihood of other people in a shared space overhearing the speaker's conversation, other participants in telecommunications often have difficulty understanding the speaker because of the reduction in loudness, vocal quality, and intelligibility associated with the soft voice type. While non-soft voice identifying automatic gain control algorithms can increase the loudness of soft speech, such algorithms often take a comparatively large amount of time to adjust the audio and are only capable of adjusting the loudness (e.g., amplitude, etc.) of received audio. Additionally, because audio including soft voice type speech often includes more prominent noise than similar audio including normal vocal effort speech (e.g., because the speaker is in a shared space, etc.), increasing the gain also amplifies the noise in the received audio.

Examples disclosed herein modify received audio including soft voice type speech by identifying such speech including soft vocal effort and adjusting the audio based on the identification. In some examples disclosed herein, lightweight machine learning, neural net-based systems detect different voice types in real-time. In some examples disclosed herein, after identifying that received audio includes speech with a soft voice type, a predefined amount of gain is applied to the audio, which causes the remote listener to receive more intelligible audio substantially faster than non-soft voice identifying automatic gain control techniques. In some such examples disclosed herein, the predefined amount of gain is approximately 8 decibels. In some examples disclosed herein, after identifying that received audio includes speech with a soft voice type, a noise reduction algorithm is applied to the audio. In some examples disclosed herein, after identifying that received audio includes speech with a soft voice type, a soft voice type to normal voice type increase pitch transformation algorithm can be applied to the audio. Examples disclosed herein the quality of audio received by remote listeners over non-soft voice identifying automatic gain control techniques.

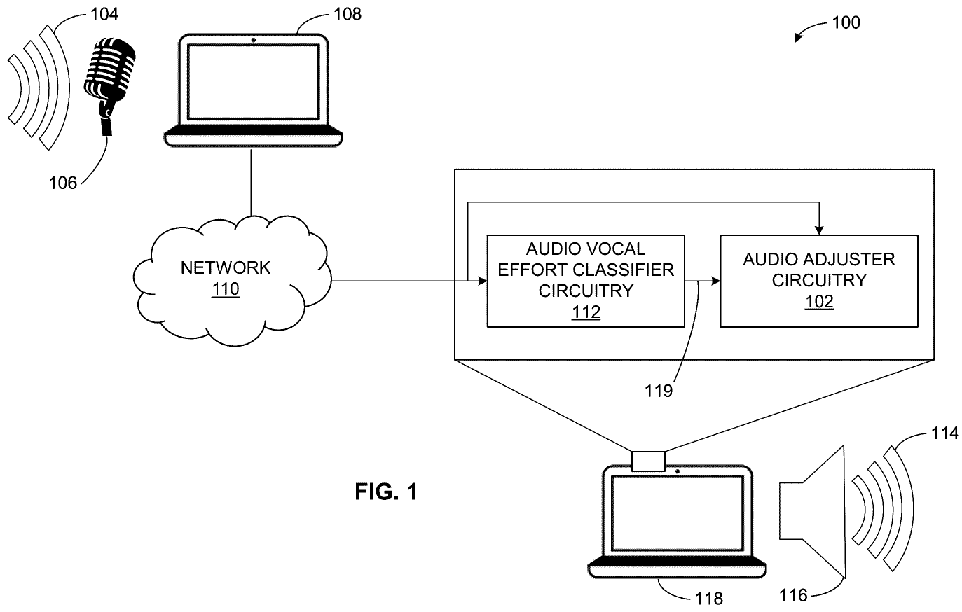

FIG. 1 is a block diagram of an example environment 100 in which an example audio adjuster circuitry 102 is to adjust the audio characteristics of example input audio 104 including speech with a soft voice type. In the illustrated example of FIG. 1, the example input audio 104 is captured by an example microphone 106 of an example first user device 108. In the illustrated example of FIG. 1, the input audio 104 is transmitted over an example network 110 and is processed by an example audio vocal effort classifier circuitry 112 and the audio adjuster circuitry 102 to generate example output audio 114. In the illustrated example of FIG. 1, the output audio 114 is output by an example speaker 116 of an example second user device 118.

In the illustrated example of FIG. 1, the input audio 104 is captured live (e.g., substantially real time, etc.) by the microphone 106. In some examples, the input audio 104 can be audio from a business meeting, a peer-to-peer communication, a public speech, a lecture, a dramatic production, etc. In some such examples, the input audio 104 can be delivered by a speaker in a public space (e.g., a coffee shop, a shared workspace, an airport, etc.) and/or a private space with other individuals (e.g., an office, a home including multiple workers, etc.). In some examples, the input audio 104 includes speech having an associated vocal effort (e.g., whispered vocal effort, soft vocal effort, normal vocal effort, loud vocal effort, yelled vocal effort, etc.). In some examples, the input audio 104 can correspond to the audio portion of captured multimedia information (e.g., part of video information, etc.). Additionally or alternatively, the microphone 106 and the first user device 108 can be absent and the input audio 104 can be stored (e.g., digitally stored, physically stored, etc.) information in a database, which can be accessed and processed by the audio vocal effort classifier circuitry 112 and/or the audio adjuster circuitry 102. For example, the input audio 104 can correspond to any recorded live-captured event and/or other media (e.g., recorded music, movies, television programming, historical recordings, commercials, etc.).

The microphone 106 is a transducer that converts the sound emitted by a sound source (e.g., a speaker, etc.) into an audio signal. In the illustrated example, the microphone 106 is a component of the first user device 108. In other examples, the microphone 106 can be an independent device coupled to the first user device 108. In some examples, the microphone can include an audio-to-digital converter to digitize the input audio 104. The user devices 108, 118 are devices that can capture and/or output audio and/or video information. In some examples, the first user device 108 and/or the second user device 118 are associated with one or more speaker(s) (e.g., source(s) of the input audio 104, etc.) and one or more remote listener(s) (e.g., receiver(s) of the output audio 114, etc.). In some examples, the first user device 108 and/or the second user device 118 can be computer(s), a mobile device(s) (e.g., smartphone(s), tablet(s), etc.), navigation device(s) and/or wearable device(s) (e.g., smart watch(s), etc.). In the illustrated example of FIG. 1, the user devices 108, 118 communicate via the network 110. In some examples, the network 110 is a local area network (LAN). In other examples, the network 110 is a wide area network (WAN) (e.g., the internet, a cellular network, etc.). Additionally or alternatively, the network 110 can be implemented by a wired network and/or a wireless network.

The audio vocal effort classifier circuitry 112 analyzes the input audio 104 to determine the vocal effort associated with the input audio 104. For example, the audio vocal effort classifier circuitry 112 can be implemented by a classifier machine learning system. An example machine-learning system that can be used to implement the audio vocal effort classifier circuitry 112 is disclosed in U.S. patent application Ser. No. 18/176,252, which is hereby incorporated by reference in its entirety. In other examples, the audio vocal effort classifier circuitry 112 can be implemented by any other suitable vocal effort classifier system.

In the illustrated example of FIG. 1, the audio vocal effort classifier circuitry 112 generates example audio classification data 119. In some examples, the audio vocal effort classifier circuitry 112 can output the audio classification data 119 as a vector of values (e.g., an integer, a binary output, etc.) indicating the vocal effort of the input audio 104 as a function of time. For example, the audio vocal effort classifier circuitry 112 can output the audio classification data 119 as a vector of binary values indicating if a portion of the input audio 104 includes speech with a soft voice type (e.g., a “0” indicating that a portion of the input audio 104 does not contain speech and/or contains speech of a non-soft vocal effort, a “1” indicating that the portion of the input audio 104 includes speech with a soft voice type, etc.). In other examples, the audio vocal effort classifier circuitry 112 can the audio classification data 119 as a vector of integer numbers indicating the vocal effort of a portion of the input audio 104 (e.g., “0” indicating that a portion of the input audio 104 does not contain speech, a “1” indicating that the portion of the input audio 104 includes speech with a whispered voice type, a “2” indicating that the portion of the input audio 104 includes speech with a soft voice type, a “3” indicating that the portion of the input audio 104 includes speech with a normal voice type, a “4” indicating that the portion of the input audio 104 includes speech with a loud voice type, a “5” indicating that the portion of the input audio 104 includes speech with a yelled voice type, etc.). In other examples, the audio classification data 119 can be output as any other suitable data structure indicating the vocal effort of the input audio 104 as a function of time.

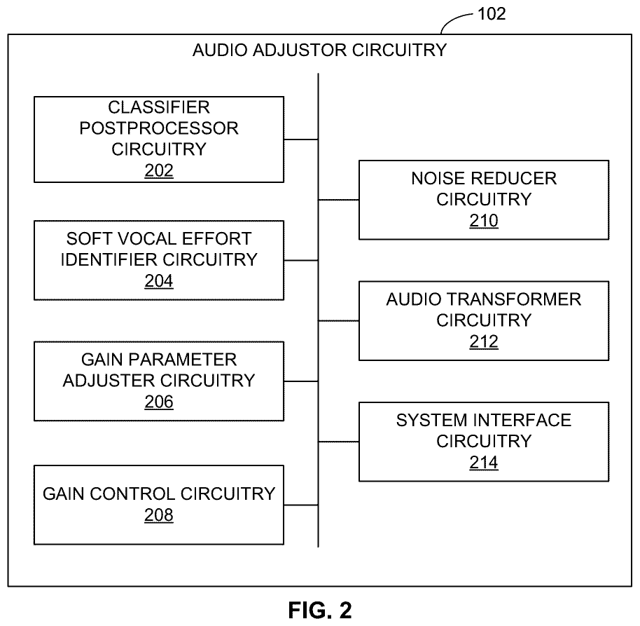

The audio adjuster circuitry 102 processes the input audio 104 and the output of the audio vocal effort classifier circuitry 112. In some examples, the audio adjuster circuitry 102 can post-process the output of the audio vocal effort classifier circuitry 112 to determine a confidence value that the input audio 104 includes speech with a soft voice type. In some such examples, the audio vocal effort classifier circuitry 112 can determine if the input audio 104 includes speech with a soft voice type by comparing the confidence value to a threshold. In some examples, if the input audio 104 does not include speech with a soft voice type, the audio adjuster circuitry 102 can apply a non-soft voice identifying automatic gain control algorithm. In some examples, if the input audio 104 does include speech with a soft voice type, the audio adjuster circuitry 102 can apply a preset amount of gain to the input audio 104. Additionally or alternatively, if the input audio 104 does include speech with a soft voice type, the audio adjuster circuitry 102 can apply a noise reduction algorithm and/or a soft-voice type to a normal-voice type adjustment algorithm. In some examples, subject listener tests on the quality of different vocal efforts indicate that regular vocal effort speech has a higher perceived quality than soft vocal effort (e.g., regular vocal effort speech has a mean opinion score of 4.2/5 and soft vocal effort speech has a mean opinion score of 2.5/5, etc.). In some such examples, the audio adjuster circuitry 102 can significantly improve the quality of such soft vocal effort speech (e.g., gain normalized soft vocal effort speech has a mean opinion score of 3.8/5, gain normalized noise reduced vocal effort speech has a mean opinion score of 3.9/5, and pitch transformed, noise reduced speech has a mean opinion score of 4.0/5, etc.). An example implementation of the audio adjuster circuitry 102 is described below in conjunction with FIG. 2.

In the illustrated example of FIG. 1, the audio adjuster circuitry 102 sends the output audio 114 to the second user device 118. In the illustrated example of FIG. 1, the output audio 114 is output by the speaker 116 of the second user device 118. The speaker 116 is a transducer that converts an audio signal (e.g., an audio signal output by the audio adjuster circuitry 102, etc.) into sound (e.g., sound associated with the output audio 114, etc.). In some examples, the speaker 116 is a component of the second user device 118. In other examples, the speaker 116 can be an independent device coupled to the second user device 118. In the illustrated example of FIG. 1, the audio adjuster circuitry 102 and the audio vocal effort classifier circuitry 112 are components of the second user device 118. In other examples, the audio adjuster circuitry 102 and/or the audio vocal effort classifier circuitry 112 can be independently implemented and/or components of other devices. For example, one or both of the audio adjuster circuitry 102 and/or the audio vocal effort classifier circuitry 112 can be components of the first user device 108. Additionally or alternatively, the audio adjuster circuitry 102 and/or the audio vocal effort classifier circuitry 112 can be implemented by a cloud computing system and/or another device in communication with the user devices 108, 118 via the network 110. While one user device (e.g., the second user device 118, etc.) and one speaker (e.g., the speaker 116, etc.) is depicted in the illustrated example of FIG. 1, in other examples, the output audio 114 can be received and output by any suitable number of user device(s) and/or speaker(s).

FIG. 2 is a block diagram of an example implementation of the audio adjuster circuitry 102 of FIG. 1 to adjust the input audio 104 to increase audio quality/fidelity. In the illustrated example of FIG. 2, the audio adjuster circuitry 102 includes example classifier postprocessor circuitry 202, example soft vocal effort identifier circuitry 204, example gain parameter adjuster circuitry 206, example gain control circuitry 208, example noise reducer circuitry 210, example audio transformer circuitry 212, and example system interface circuitry 214. The audio adjuster circuitry 102 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the audio adjuster circuitry 102 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

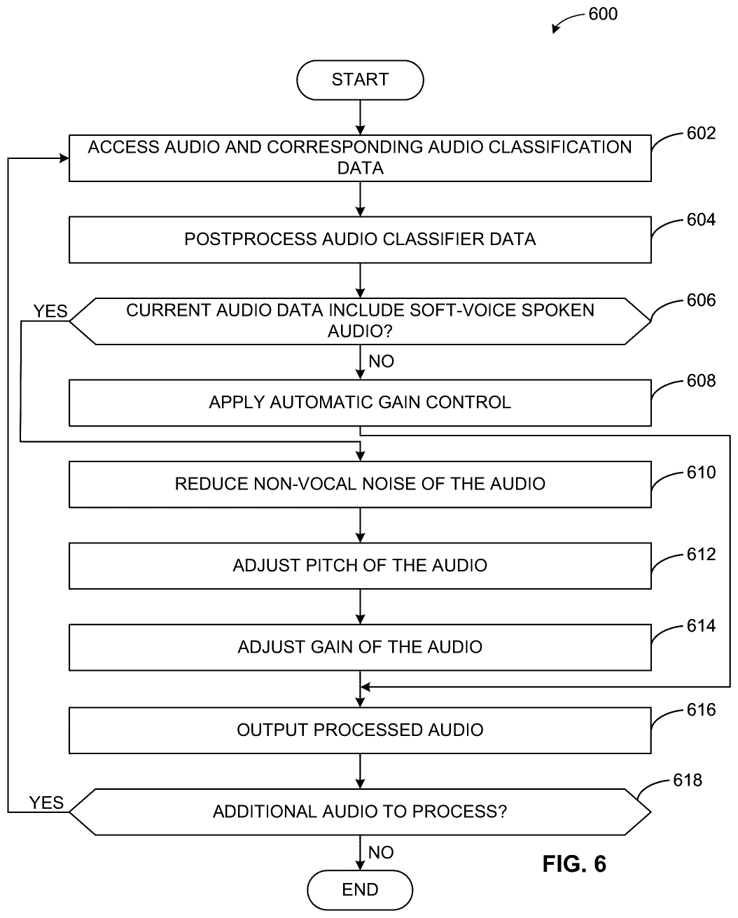

The classifier postprocessor circuitry 202 accesses the input audio 104 and corresponding audio classification data 119. For example, the classifier postprocessor circuitry 202 can continuously access the audio classification data 119 and/or the input audio 104 via the network 110. In other examples, the classifier postprocessor circuitry 202 can access the input audio 104 via a connection (e.g., a wired connection, a wireless connection, etc.) to the microphone 106 and/or the audio classification data 119 to the audio vocal effort classifier circuitry 112. In some examples, the classifier postprocessor circuitry 202 post-processes the audio classification data 119. For example, the classifier postprocessor circuitry 202 can filter, smooth, and/or weight the audio classification data 119 to generate a time-variate confidence value indicative of if the input audio 104 includes speech with a soft voice type. In some examples, the classifier postprocessor circuitry 202 can apply a moving average filter (e.g., a rolling average filter, a boxcar filter, a cumulative average filtered, a weighted moving average, etc.). Additionally or alternatively, the classifier postprocessor circuitry 202 can apply a smooth algorithm to the audio classification data 119. In other examples, the classifier postprocessor circuitry 202 can apply any other suitable post-processing to the audio classification data 119 (e.g., another filter accounting for previous inputs, a digital-to-analog converter, etc.). In some examples, the classifier postprocessor circuitry 202 is instantiated by programmable circuitry executing classifier postprocessor instructions and/or configured to perform operations such as those represented by the flowchart(s) of FIGS. 5 and 6.

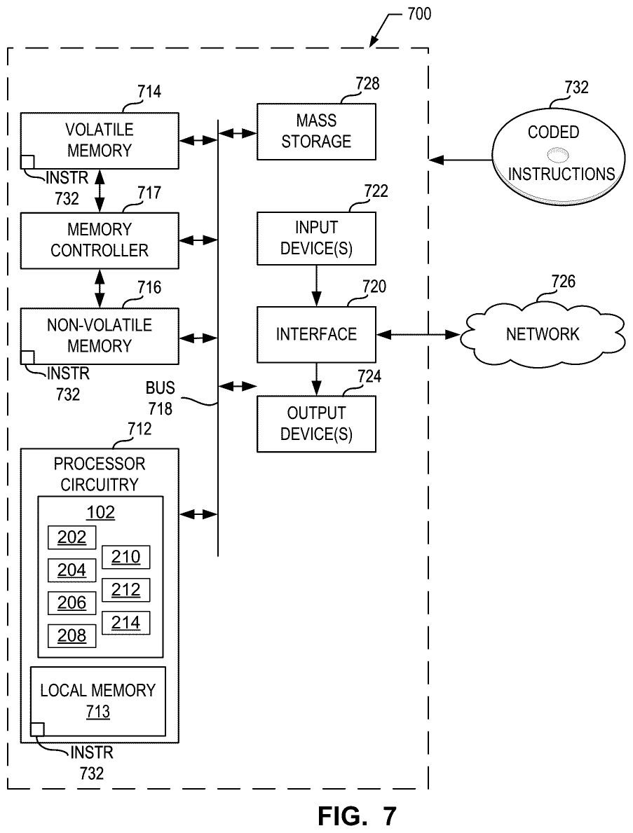

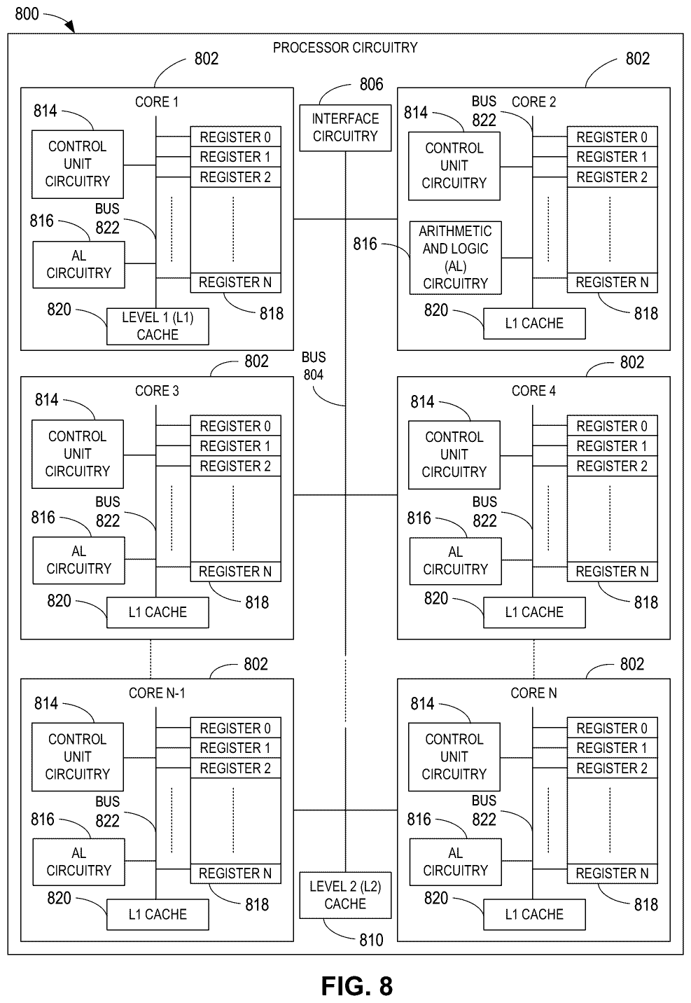

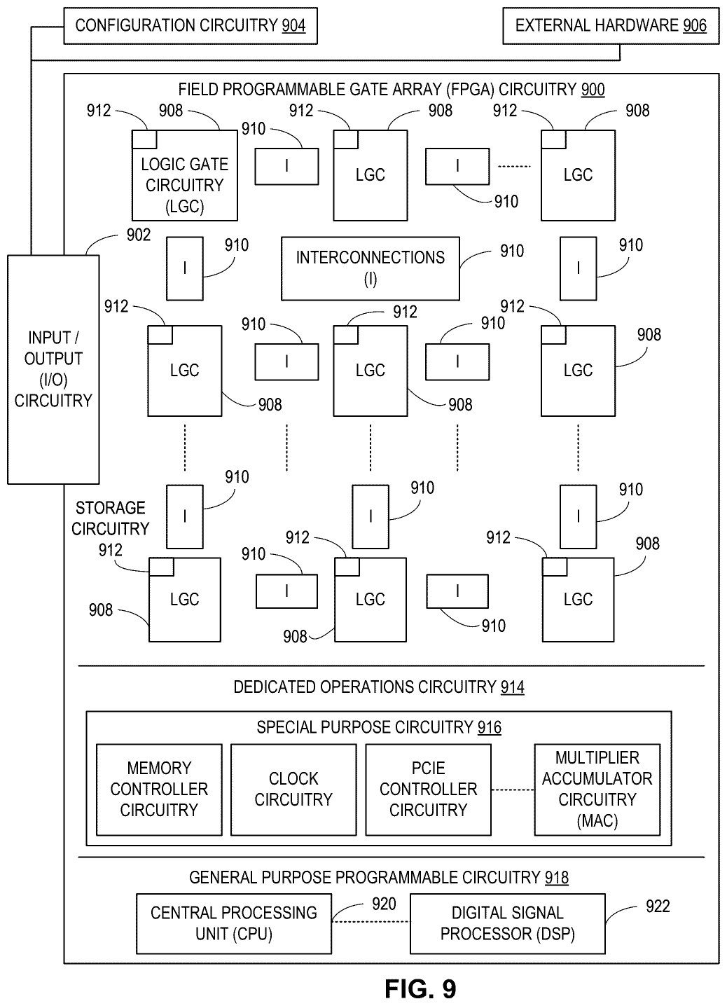

In some examples, the audio adjuster circuitry 102 includes means for postprocessing audio classifier data. For example, the means for postprocessing audio classifier data may be implemented by classifier postprocessor circuitry 202. In some examples, the classifier postprocessor circuitry 202 may be instantiated by programmable circuitry such as the example programmable circuitry 712 of FIG. 7. For instance, the classifier postprocessor circuitry 202 may be instantiated by the example microprocessor 800 of FIG. 8 executing machine executable instructions such as those implemented by at least blocks 502, 504, 506 of FIG. 5 and/or blocks 602, 604, 610. In some examples, the classifier postprocessor circuitry 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the classifier postprocessor circuitry 202 may be instantiated by any other combination of hardware, software, and/or firmware. For example, the classifier postprocessor circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

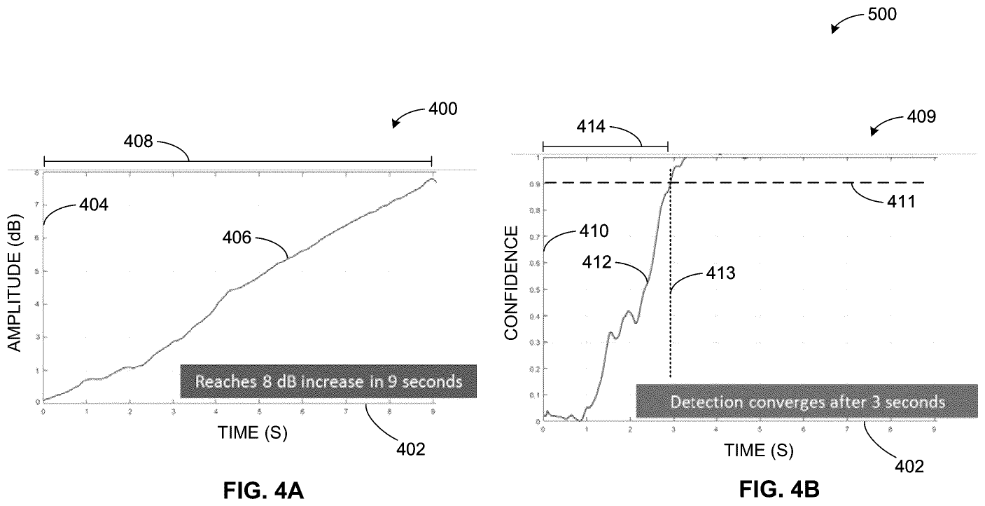

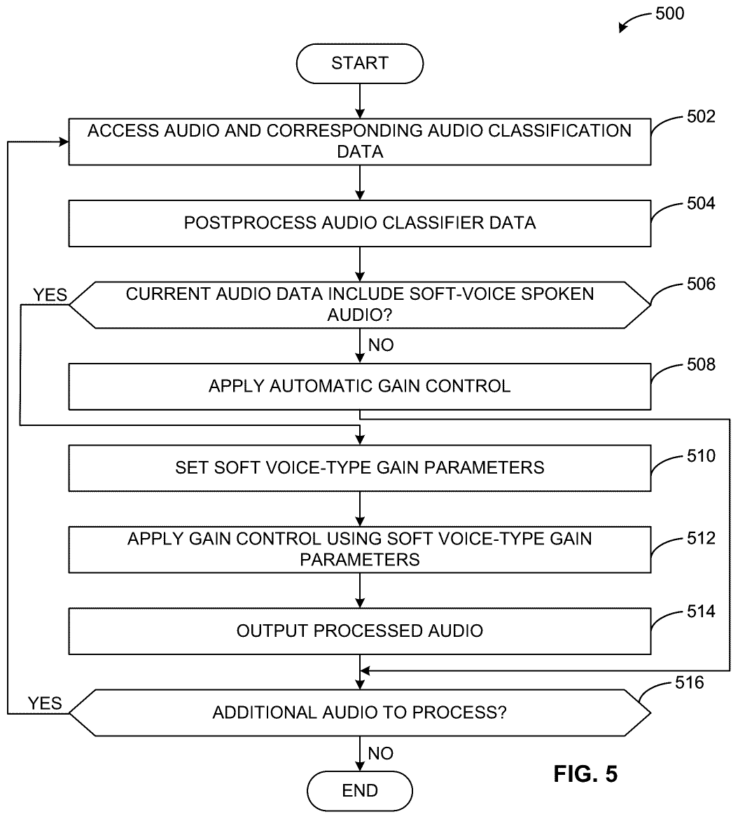

The soft vocal effort identifier circuitry 204 determines if the current portion of the input audio 104 includes speech with a soft voice type. For example, the soft vocal effort identifier circuitry 204 can compare the output of the classifier postprocessor circuitry 202 to a threshold (e.g., the threshold 411 of FIG. 4b, etc.). In some such examples, the soft vocal effort identifier circuitry 204 determines if the output of the classifier postprocessor circuitry 202 based on the comparison of the audio classification data 119 and/or the post-processed audio classification data to the threshold (e.g., if the post-processed audio classification data satisfies the threshold, etc.). In some examples, the threshold used by the soft vocal effort identifier circuitry 204 can be determined empirically, set by a user of the first user device 108, set by a user of the second user device 118, etc. Additionally or alternatively, the soft vocal effort identifier circuitry 204 can determine if the input audio 104 includes speech with a soft voice type in any other suitable manner (e.g., after a threshold number of positive outputs in the audio classification data 119, etc.). In some examples, the soft vocal effort identifier circuitry 204 is instantiated by programmable circuitry executing soft-voice identifier instructions and/or configured to perform operations such as those represented by the flowcharts of FIGS. 5 and 6.

In some examples, the audio adjuster circuitry 102 includes means for identifying soft vocal effort. For example, the means for determining may be implemented by the soft vocal effort identifier circuitry 204. In some examples, the soft vocal effort identifier circuitry 204 may be instantiated by programmable circuitry such as the example programmable circuitry 712 of FIG. 7. For instance, the soft vocal effort identifier circuitry 204 may be instantiated by the example microprocessor 800 of FIG. 8 executing machine executable instructions such as those implemented by at least block 506 of FIG. 5 and/or block 606 of FIG. 6. In some examples, the soft vocal effort identifier circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the soft vocal effort identifier circuitry 204 may be instantiated by any other combination of hardware, software, and/or firmware. For example, the soft vocal effort identifier circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

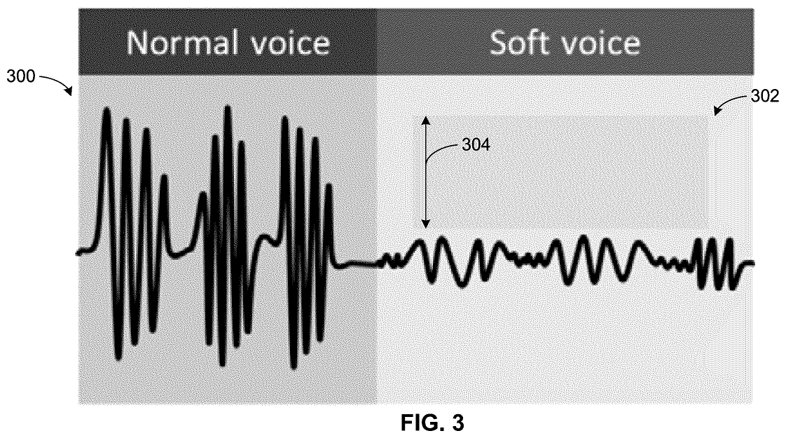

The gain parameter adjuster circuitry 206 sets the soft voice type gain parameters. In some examples, the gain parameter adjuster circuitry 206 can set a preset gain based on the average difference in amplitude between the soft voice type and the normal voice type speech (e.g., the difference 304 of FIG. 3, 8 dB, etc.). In other examples, the gain parameter adjuster circuitry 206 can determine the soft voice type gain parameters based on a particular user of the first user device 108 (e.g., based on previous inputs from the user into the first user device 108, etc.). In some examples, the gain parameter adjuster circuitry 206 can access the soft voice type gain from a memory associated with the audio adjuster circuitry 102. In some examples, the gain parameter adjuster circuitry 206 is instantiated by programmable circuitry executing gain parameter adjuster instructions and/or configured to perform operations such as those represented by the flowchart(s) of FIGS. 5 and 6.

In some examples, the audio adjuster circuitry 102 includes means for adjusting a gain value. For example, the means for adjusting a gain value may be implemented by the gain parameter adjuster circuitry 206. In some examples, the gain parameter adjuster circuitry 206 may be instantiated by programmable circuitry such as the example programmable circuitry 712 of FIG. 7. For instance, the gain parameter adjuster circuitry 206 may be instantiated by the example microprocessor 800 of FIG. 8 executing machine executable instructions such as those implemented by at least block 510 of FIG. 5. In some examples, the gain parameter adjuster circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the gain parameter adjuster circuitry 206 may be instantiated by any other combination of hardware, software, and/or firmware. For example, the gain parameter adjuster circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The gain control circuitry 208 applies one or more gains to the input audio 104. For example, the gain control circuitry 208 applies the soft voice type gain to the input audio 104. For example, the gain control circuitry 208 can increase the amplitude and/or loudness of the input audio 104 based on the voice type gain determined by the gain parameter adjuster circuitry 206. In some examples, the gain control circuitry 208 can apply automatic gain control (AGC) to the input audio 104. For example, the gain control circuitry 208 can apply a non-soft voice identifying AGC algorithm to the input audio 104. In some examples, the gain control circuitry 208 is instantiated by programmable circuitry executing gain control instructions and/or configured to perform operations such as those represented by the flowchart of FIG. 5.

In some examples, the audio adjuster circuitry 102 includes means for controlling the gain applied to audio. For example, the means for controlling the gain applied to audio may be implemented by the gain control circuitry 208. In some examples, the gain control circuitry 208 may be instantiated by programmable circuitry such as the example programmable circuitry 712 of FIG. 7. For instance, the gain control circuitry 208 may be instantiated by the example microprocessor 800 of FIG. 8 executing machine executable instructions such as those implemented by at least blocks 508, 512 of FIG. 5. In some examples, the gain control circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the gain control circuitry 208 may be instantiated by any other combination of hardware, software, and/or firmware. For example, the gain control circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The noise reducer circuitry 210 reduces the noise of the input audio 104. For example, because the soft vocal effort identifier circuitry 204 identified that the input audio includes speech with a soft voice type, the noise reducer circuitry 210 can apply a noise reduction algorithm to the input audio 104 to reduce the non-speech noise in the input audio 104. In some examples, the noise reducer circuitry 210 can remove frequency bands in the input audio 104 that are not associated with human speech. In some examples, the noise reducer circuitry 210 can use one or more filters to remove non-speech audio (e.g., a low pass filter, a band pass filter, a high pass filter, etc.). In some examples, the noise reducer circuitry 210 can use Wiener filtering. In some examples, the noise reducer circuitry 210 can use a machine-learning and/or artificial intelligence system to reduce the non-speech sounds in the input audio 104. In some examples, the noise reducer circuitry 210 is instantiated by programmable circuitry executing noise reduction instructions and/or configured to perform operations such as those represented by the flowchart of FIG. 6.

In some examples, the audio adjuster circuitry 102 includes means for reducing noise. For example, the means for reducing noise may be implemented by the noise reducer circuitry 210. In some examples, the noise reducer circuitry 210 may be instantiated by programmable circuitry such as the example programmable circuitry 712 of FIG. 7. For instance, the noise reducer circuitry 210 may be instantiated by the example microprocessor 800 of FIG. 8 executing machine executable instructions such as those implemented by at least block 610 of FIG. 6 In some examples, the noise reducer circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the noise reducer circuitry 210 may be instantiated by any other combination of hardware, software, and/or firmware. For example, the noise reducer circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The audio transformer circuitry 212 adjusts the pitch of the input audio 104. For example, the audio transformer circuitry 212 can adjust the pitch of the input audio 104 from a range associated with soft vocal speech to a range associated with normal vocal effort speech. For example, speech with a soft voice type often has a lower pitch than normal vocal effort speech. In some such examples, the audio transformer circuitry 212 can increase the pitch of the input audio to a range associated with normal vocal effort speech. In some examples, the audio transformer circuitry 212 can determine the pitch adjustment based on vocal samples from a user of the first user device 108 (e.g., the current speaker, etc.). Additionally or alternatively, the audio transformer circuitry 212 can determine the pitch adjustment via a machine learning system. Additionally or alternatively, the audio transformer circuitry 212 can determine the pitch adjustment based on a preset pitch adjustment (e.g., based on empirical measurements of a plurality of speakers, etc.). In some examples, the audio transformer circuitry 212 adjusts the gain of the input audio 104. For example, the audio transformer circuitry 212 can increase the gain of the input audio by a present amount (e.g., the difference 304 of FIG. 3, 8 dB, etc.). In other examples, the audio transformer circuitry 212 can apply any other suitable gain to input audio 104. (e.g., based on a particular user of the first user device 108, based on previous inputs from the user into the first user device 108, etc.). In some examples, the audio transformer circuitry 212 is instantiated by programmable circuitry executing the audio transformer instructions and/or configured to perform operations such as those represented by the flowchart of FIG. 6.

In some examples, the audio adjuster circuitry includes means for transforming audio. For example, the means for transforming audio may be implemented by the audio transformer circuitry 212. In some examples, the audio transformer circuitry 212 may be instantiated by programmable circuitry such as the example programmable circuitry 712 of FIG. 7. For instance, the audio transformer circuitry 212 may be instantiated by the example microprocessor 800 of FIG. 8 executing machine executable instructions such as those implemented by at least blocks 612, 614 of FIG. 6. In some examples, the audio transformer circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the audio transformer circuitry 212 may be instantiated by any other combination of hardware, software, and/or firmware. For example, the audio transformer circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The system interface circuitry 214 interfaces with system components of the user devices 108, 118. For example, the system interface circuitry 214 outputs the output audio 114. For example, the system interface circuitry 214 can output the output audio 114 generated by the gain control circuitry 208 during the execution of the block 508 and/or the execution of the block 512 via the speaker 116. In some examples, the system interface circuitry 214 is instantiated by programmable circuitry executing system interface instructions and/or configured to perform operations such as those represented by the flowchart of FIGS. 5 and 6.

In some examples, the audio adjuster circuitry 102 includes means for determining a condition of a device. For example, the means for determining may be implemented by the system interface circuitry 214. In some examples, t the system interface circuitry 214 may be instantiated by programmable circuitry such as the example programmable circuitry 712 of FIG. 7. For instance, the system interface circuitry 214 may be instantiated by the example microprocessor 800 of FIG. 8 executing machine executable instructions such as those implemented by at least blocks 514, 516 of FIG. 5 and the blocks 616, 618 of FIG. 6. In some examples, the system interface circuitry 214 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the system interface circuitry 214 may be instantiated by any other combination of hardware, software, and/or firmware. For example, the system interface circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the audio adjuster circuitry of FIG. 1 is illustrated in FIG. 2, one or more of the elements, processes, and/or devices illustrated in FIG. 2 may be combined, divided, re-arranged, omitted, eliminated, and/or implemented in any other way. Further, the classifier postprocessor circuitry 202, the soft vocal effort identifier circuitry 204, the gain parameter adjuster circuitry 206, the gain control circuitry 208, the noise reducer circuitry 210, the audio transformer circuitry 212, the system interface circuitry 214, and/or, more generally, the example audio adjuster circuitry 102 of FIG. 2, may be implemented by hardware alone or by hardware in combination with software and/or firmware. Thus, for example, any of the classifier postprocessor circuitry 202, the soft vocal effort identifier circuitry 204, the gain parameter adjuster circuitry 206, the gain control circuitry 208, the noise reducer circuitry 210, the audio transformer circuitry 212, and the system interface circuitry 214, and/or, more generally, the example audio adjuster circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example audio adjuster circuitry 102 of FIG. 2 may include one or more elements, processes, and/or devices in addition to, or instead of, those illustrated in FIG. 2, and/or may include more than one of any or all of the illustrated elements, processes and devices.

FIG. 3 is a graphic representation of the amplitude of example first speech 300 made with a normal voice type and the amplitude of example second speech 302 with a soft voice type. In the illustrated example of FIG. 3, the first speech 300 and the second speech 302 have an example difference 304 in amplitude (e.g., a difference measured from a peak of the amplitude of the example first speech 300 and a peak of the amplitude of the example second speech 302). In some examples, the difference is approximately 8 decibels (dB), which is based on empirical observation of human speech. As used herein, “approximately 8 decibels” refers to any quantity between 7 dB and 9 dB. For example, the difference 304 is determined by analyzing the soft voice and the normal voice of a group of speakers. In some such examples, the difference 304 was determined as the average difference between the soft voice and the normal voice of each of the group of speakers. In some such examples, the audio adjuster circuitry 102 can adjust audio with a soft voice by increasing the gain of such audio by 8 dB.

In other examples, the audio adjuster circuitry 102 (e.g., the gain parameter adjuster circuitry 206, etc.) can determine the difference 304 on a per-user basis. In some such examples, the audio adjuster circuitry 102 can prompt a user of the first user device 108 to provide vocal samples with a normal voice type and a soft vocal effort (e.g., captured via the microphone 106, etc.). Additionally or alternatively, the audio adjuster circuitry 102 can determine the difference 304 in substantially real-time based on the output of the audio vocal effort classifier circuitry 112 (e.g., determining the average vocal difference between speech identified as a soft vocal effort by the audio vocal effort classifier circuitry 112 and speech identified as a normal vocal effort by the audio vocal effort classifier circuitry 112, etc.). In some examples, the audio adjuster circuitry 102 can determine the difference 304 based on the amplitudes of the soft voice samples and the normal voice samples associated with the user. In other examples, the audio adjuster circuitry 102 can determine the difference 304 in any other suitable manner.

FIG. 4A is a first graph 400 illustrating the function of a non-soft voice identifying automatic gain control (AGC) algorithm over time. In FIG. 4A, the graph 400 includes an x-axis 402 and a y-axis 404. The x-axis 402 measures the independent variable time. In FIG. 4A, the x-axis 402 has seconds as units. In other examples, the x-axis can have any other unit of time. The y-axis 404 measures the gain adjustment provided by the non-soft voice identifying AGC. In FIG. 4, the y-axis has dBs as units. In other examples, the y-axis can have any other unit of gain and/or loudness.

In FIG. 4A, the first graph 400 includes a line 406, which tracks the movement of the gain adjustment provided by the non-soft voice identifying AGC algorithm after a speaker changes from speaking with a normal voice type to speaking with a soft voice type at “0” on the x-axis 402. In FIG. 4A, because non-soft voice identifying AGC algorithms operate gradually (e.g., to avoid sharp changes in loudness, etc.), the line 406 takes a first duration 408 to reach a loudness change of 8 decibels (e.g., “8” on the y-axis 404, etc.). In FIG. 4A, the first duration 408 is approximately 9 seconds (e.g., “9” on the x-axis 402, etc.). Because the amplitude difference between speech with a soft voice type and a normal voice type is typically 8 dB (e.g., the difference 304 of FIG. 3, etc.), during the first duration 408, a listener can have difficulty understanding the speech associated with the line 406 because of the low loudness of the speech. In some examples, the listen may need to frequently adjust the volume (e.g., the volume of the second user device 118, etc.) during the first duration 408 and after the first duration 408 to ensure the listener can understand the speaker. Such frequent volume adjustments can have negative impacts on the listener's experience.

FIG. 4B is an example second graph 409 illustrating the function of the example audio adjuster circuitry 102 of FIGS. 1 and 2 (e.g., the classifier postprocessor circuitry 202 and the soft vocal effort identifier circuitry 204, etc.). In the illustrated example of FIG. 4B, the graph 409 includes the x-axis 402 of FIG. 4A and an example y-axis 410. The y-axis 410 measures a confidence value output by the audio adjuster circuitry 102 (e.g., the classifier postprocessor circuitry 202, etc.). In the illustrated example of FIG. 4A, the y-axis 410 ranges between “0” (e.g., corresponding to complete confidence that a portion of audio does not contain speech with a soft voice type, etc.) and “1” (e.g., corresponding to complete confidence that audio does contain speech with a soft voice type, etc.). In other examples, the y-axis 410 can have any other suitable range. In the illustrated example of FIG. 4B, the y-axis 410 includes an example threshold 411.

In the illustrated example of FIG. 4B, the second graph 409 includes an example line 412, which tracks the audio adjuster circuitry 102 after a speaker changes from speaking with a normal voice type to speaking with a soft voice type at “0” on the x-axis 402. In the illustrated example of FIG. 4B, the line 412 is an example output of the classifier postprocessor circuitry 202 after the post-processing of the audio classification data 119. As described above in conjunction with FIG. 2, the classifier postprocessor circuitry 202 of the audio adjuster circuitry 102 can process the output of audio classification data 119 by filtering, averaging, and/or smoothing the output of the audio vocal effort classifier circuitry 112. In the illustrated example of FIG. 4B, the line 412 is generated by applying a moving average filter to the audio classification data 119. Because the audio vocal effort classifier circuitry 112 continuously outputs a binary value of either “0” or “1” for the analyzed audio, the value of the line 412 can similarly vary between “0” or “1.” In the illustrated example of FIG. 4B, because the line 412 is generated by applying a moving average filter to the audio classification data 119 and the speaker has switched to speaking with a soft voice type, the line 412 increases and crosses the example threshold 411 at an example time 413. In the illustrated example of FIG. 4B, the threshold 411 is “0.9” on the y-axis 410. In the illustrated example of FIG. 4B, the time 413 occurs at an example second duration 414 after “0” on the x-axis 402. As used herein, the time 413 is referred to as the “convergence time.”

At the time 413, the soft vocal effort identifier circuitry 204 compares the value of the line 412 to the threshold 411 and based on this comparison, determines that the speaker is speaking with a soft voice type. In some such examples, the gain parameter adjuster circuitry 206 can generate a gain to compensate for the soft vocal effort of the speaker (e.g., 8 dB, the difference 304 of FIG. 3, etc.), which can be immediately applied to the audio by the gain control circuitry 208 at the time 413. In the illustrated example of FIG. 4B, the second duration 414 is approximately 3 seconds (e.g., “3” on the x-axis 402, etc.). In the illustrated example of FIGS. 4A and 4B, the second duration 414 is substantially shorter than the first duration 408 (e.g., 3 times shorter, 6 seconds shorter, etc.). As such, the audio adjuster circuitry 102 substantially reduces the amount of time when speech with a soft voice type can be difficult to understand by a remote listener when compared to non-soft voice identifying AGC algorithms.

In some examples, the threshold 411 and the postprocessing applied to the output of the audio vocal effort classifier circuitry 112 can be modified to adjust the length of the second duration 414. For example, the threshold 411 can be lowered (e.g., to 0.8, 0.5, etc.), and/or the filter can be weighted to increase the weight of more recent values to decrease the second duration 414. In some examples, the values of the threshold 411 and the parameters and/or type of filter used by the classifier postprocessor circuitry 202 of the audio adjuster circuitry 102 can be determined empirically to reduce the convergence time, while avoiding an undesirable amount of false identification of soft vocal efforts.

Flowchart(s) representative of example machine readable instructions, which may be executed by programmable circuitry to implement and/or instantiate the audio adjuster circuitry of FIG. 2 and/or representative of example operations which may be performed by programmable circuitry to implement and/or instantiate the audio adjuster circuitry of FIG. 2, are shown in FIGS. 5 and 6. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5 and 6, many other methods of implementing the example audio adjuster circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed, instantiated, and/or performed by programmable circuitry to adjust the input audio 104 of FIG. 1 based on the presence of soft vocal speech in the input audio 104 via a first technique (e.g., the “preset gain adjustment technique”). It should be appreciated that the operations 500 are executed continuously for the received input audio 104 such that substantially real-time communications can be maintained between the first user device 108 and the second user device 118. That is, the operations 500 can execute continuously on discrete portions of the input audio 104 such that there is minimal delay (e.g., substantially real-time, etc.) between an input of a portion of the audio 10 into the microphone 106 and an output of a corresponding portion of the output audio 116 via the speaker 114.

The example machine-readable instructions and/or the example operations 500 of FIG. 5 begin at block 502, at which the classifier postprocessor circuitry 202 accesses the input audio 104 and corresponding audio classification data 119. For example, the classifier postprocessor circuitry 202 can continuously access the audio classification data 119 and/or the input audio 104 via the network 110. In other examples, the classifier postprocessor circuitry 202 can access the input audio 104 via a connection (e.g., a wired connection, a wireless connection, etc.) to the microphone 106 and/or the audio classification data 119 to the audio vocal effort classifier circuitry 112. At block 504, the classifier postprocessor circuitry 202 post-processes the audio classification data 119. For example, the classifier postprocessor circuitry 202 can filter, smooth, and/or weight the audio classification data 119 to generate a time-variate confidence value indicative of if the input audio 104 includes speech with a soft voice type. In some examples, the classifier postprocessor circuitry 202 can apply a moving average filter (e.g., a rolling average filter, a boxcar filter, a cumulative average filtered, a weighted moving average, etc.). Additionally or alternatively, the classifier postprocessor circuitry 202 can apply a smooth algorithm to the audio classification data 119. In other examples, the classifier postprocessor circuitry 202 can apply any other suitable post-processing to the audio classification data 119 (e.g., another filter accounting for previous inputs, a digital-to-analog converter, etc.).

At block 506, the soft vocal effort identifier circuitry 204 determines if the current portion of the input audio 104 includes speech with a soft voice type. For example, the soft vocal effort identifier circuitry 204 can compare the output of the classifier postprocessor circuitry 202 to a threshold (e.g., the threshold 411 of FIG. 4b, etc.). In some such examples, the soft vocal effort identifier circuitry 204 determines if the output of the classifier postprocessor circuitry 202 based on the comparison of the audio classification data 119 and/or the post-processed audio classification data to the threshold (e.g., if the post-processed audio classification data satisfies the threshold, etc.). Additionally or alternatively, the soft vocal effort identifier circuitry 204 can determine if the input audio 104 includes speech with a soft voice type in any other suitable manner (e.g., after a threshold number of positive outputs in the audio classification data 119, etc.). If the soft vocal effort identifier circuitry 204 determines if the current portion of the input audio 104 includes speech with a soft voice type, the operations 500 advance to block 510. If the soft vocal effort identifier circuitry 204 determines if the current portion of the input audio 104 does not include speech with a soft voice type, the operations 500 advance to block 508. At block 508, the gain control circuitry 208 applies automatic gain control (AGC) to the input audio 104. For example, the gain control circuitry 208 can apply a non-soft voice identifying AGC algorithm to the input audio 104. After the execution of block 508, the operations 500 advanced to block 514.

At block 510, the gain parameter adjuster circuitry 206 sets the soft voice type gain parameters. In some examples, the gain parameter adjuster circuitry 206 can set a preset gain based on the average difference in amplitude between soft voice type and the normal voice type speech (e.g., the difference 304 of FIG. 3, 8 dB, etc.). In other examples, the gain parameter adjuster circuitry 206 can determine the soft voice type gain parameters based on a particular user of the first user device 108 (e.g., based on previous inputs from the user into the first user device 108, etc.). In some examples, the gain parameter adjuster circuitry 206 can access the soft voice type gain parameter (e.g., value, etc.) from a memory associated with the audio adjuster circuitry 102. At block 512, the gain control circuitry 208 applies the soft voice type gain to the input audio 104. For example, the gain control circuitry 208 can increase the amplitude and/or loudness of the input audio 104 based on the voice type gain determined by the gain parameter adjuster circuitry 206 during the execution of block 510.

At block 514, the system interface circuitry 214 outputs the output audio 114. For example, the system interface circuitry 214 can output the output audio 114 generated by the gain control circuitry 208 during the execution of the block 508 and/or the execution of the block 512 via the speaker 116. At block 516, the system interface circuitry 214 and/or the classifier postprocessor circuitry 202 can determine if there is additional information to be processed. For example, the system interface circuitry 214 and/or the classifier postprocessor circuitry 202 can determine if the input audio 104 and/or the audio classification data 119 is still being accessed. In other examples, the system interface circuitry 214 and/or the classifier postprocessor circuitry 202 can be determined based on a power status of the first user device 108, the second user device 118, and/or a conferencing service executing on one or both of the user devices 108, 118. If the system interface circuitry 214 and/or the classifier postprocessor circuitry 202 determines there is additional audio to be processed, the operations 500 return to block 504. If the system interface circuitry 214 and/or the classifier postprocessor circuitry 202 determines there is no additional audio to be processed, the operations 500 end.

FIG. 6 is a flowchart representative of example machine readable instructions and/or example operations 600 that may be executed, instantiated, and/or performed by programmable circuitry to adjust the input audio 104 of FIG. 1 based on the presence of soft vocal speech in the input audio 104 via a first technique (e.g., the “audio transformation technique”). It should be appreciated that the operations 500 are executed continuously for the received input audio 104 such that substantially real-time communications can be maintained between the first user device 108 and the second user device 118. That is, the operations 500 can execute continuously on discrete portions of the input audio 104 such that there is minimal delay (e.g., substantially real-time, etc.) between an input of a portion of the audio 10 into the microphone 106 and an output of a corresponding portion of the output audio 114 via the speaker 116.

The example machine-readable instructions and/or the example operations 500 of FIG. 6 begin at block 602, at which the classifier postprocessor circuitry 202 accesses the input audio 104 and corresponding audio classification data 119. For example, the classifier postprocessor circuitry 202 can continuously access the audio classification data 119 and/or the input audio 104 via the network 110. In other examples, the classifier postprocessor circuitry 202 can access the input audio 104 via a connection (e.g., a wired connection, a wireless connection, etc.) to the microphone 106 and/or the audio classification data 119 to the audio vocal effort classifier circuitry 112. At block 604, the classifier postprocessor circuitry 202 post-processes the audio classification data 119. For example, the classifier postprocessor circuitry 202 can filter, smooth, and/or weight the audio classification data 119 to generate a time-variate confidence value indicative of if the input audio 104 includes speech with a soft voice type. In some examples, the classifier postprocessor circuitry 202 can apply a moving average filter (e.g., a rolling average filter, a boxcar filter, a cumulative average filtered, a weighted moving average, etc.). Additionally or alternatively, the classifier postprocessor circuitry 202 can apply a smooth algorithm to the audio classification data 119. In other examples, the classifier postprocessor circuitry 202 can apply any other suitable post-processing to the audio classification data 119 (e.g., another filter accounting for previous inputs, a digital-to-analog converter, etc.).

At block 606, the soft vocal effort identifier circuitry 204 determines if the current portion of the input audio 104 includes speech with a soft voice type. For example, the soft vocal effort identifier circuitry 204 can compare the output of the classifier postprocessor circuitry 202 to a threshold (e.g., the threshold 411 of FIG. 4B, etc.). In some such examples, the soft vocal effort identifier circuitry 204 determines if the output of the classifier postprocessor circuitry 202 based on the comparison of the audio classification data 119 and/or the post-processed audio classification data to the threshold (e.g., if the post-processed audio classification data satisfies the threshold, etc.). Additionally or alternatively, the soft vocal effort identifier circuitry 204 can determine if the input audio 104 includes speech with a soft voice type in any other suitable manner (e.g., after a threshold number of positive outputs in the audio classification data 119, etc.). If the soft vocal effort identifier circuitry 204 determines if the current portion of the input audio 104 includes speech with a soft voice type, the operations 600 advance to block 610. If the soft vocal effort identifier circuitry 204 determines if the current portion of the input audio 104 does not include speech with a soft voice type, the operations 600 advance to block 608. At block 608, the gain control circuitry 208 applies automatic gain control (AGC) to the input audio 104. For example, the gain control circuitry 208 can apply a non-soft voice identifying AGC algorithm to the input audio 104. After the execution of block 608, the operations 600 advance to block 614.

At block 610, the noise reducer circuitry 210 reduces the noise of the input audio 104. For example, because the soft vocal effort identifier circuitry 204 identified that the input audio includes speech with a soft voice type, the noise reducer circuitry 210 can apply a noise reduction algorithm to the input audio 104 to reduce the non-speech noise in the input audio 104. In some examples, the noise reducer circuitry 210 can remove frequency bands in the input audio 104 that are not associated with human speech. In some examples, the noise reducer circuitry 210 can use one or more filters to remove non-speech audio (e.g., a low pass filter, a band pass filter, a high pass filter, etc.). In some examples, the noise reducer circuitry 210 can use Wiener filtering. In some examples, the noise reducer circuitry 210 can use a machine-learning and/or artificial intelligence system to reduce the non-speech sounds in the input audio 104.

At block 612, the audio transformer circuitry 212 adjusts the pitch of the input audio 104. For example, the audio transformer circuitry 212 can adjust the pitch of the input audio 104 from a range associated with soft vocal speech to a range associated with normal vocal effort speech. For example, speech with a soft voice type often has a lower pitch than normal vocal effort speech. In some such examples, the audio transformer circuitry 212 can increase the pitch of the input audio to a range associated with normal vocal effort speech. In some examples, the audio transformer circuitry 212 can determine the pitch adjustment based on vocal samples from a user of the first user device 108 (e.g., the current speaker, etc.). Additionally or alternatively, the audio transformer circuitry 212 can determine the pitch adjustment via a machine learning system. Additionally or alternatively, the audio transformer circuitry 212 can determine the pitch adjustment based on a preset pitch adjustment (e.g., based on empirical measurements of a plurality of speakers, etc.).

At block 614, the audio transformer circuitry 212 adjusts the gain of the input audio 104. For example, the audio transformer circuitry 212 can increase the gain of the input audio by a present amount (e.g., the difference 304 of FIG. 3, 8 dB, etc.). In other examples, the audio transformer circuitry 212 can apply any other suitable gain to input audio 104. (e.g., based on a particular user of the first user device 108, based on previous inputs from the user into the first user device 108, etc.).

At block 616, the system interface circuitry 214 outputs the output audio 114. For example, the system interface circuitry 214 can output the output audio 114 generated during the execution of the block 608 and/or the executions of the blocks 610, 612, 614 via the speaker 116. At block 618, the system interface circuitry 214 and/or the classifier postprocessor circuitry 202 can determine if there is additional information to be processed. For example, the system interface circuitry 214 and/or the classifier postprocessor circuitry 202 can determine if the input audio 104 and/or the audio classification data 119 is still being accessed. In other examples, the system interface circuitry 214 and/or the classifier postprocessor circuitry 202 can be determined based on a power status of the first user device 108, the second user device 118, and/or a conferencing service executing on one or both of the user devices 108, 118. If the system interface circuitry 214 and/or the classifier postprocessor circuitry 202 determines there is additional audio to be processed, the operations 600 return to block 604. If the system interface circuitry 214 and/or the classifier postprocessor circuitry 202 determines there is no additional audio to be processed, the operations 600 end.

FIG. 7 is a block diagram of an example programmable circuitry platform 700 structured to execute and/or instantiate the example machine-readable instructions and/or the example operations of FIGS. 5 and 6 to implement the audio adjuster circuitry of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the classifier postprocessor circuitry 202, the soft vocal effort identifier circuitry 204, the gain parameter adjuster circuitry 206, the gain control circuitry 208, the noise reducer circuitry 210, the audio transformer circuitry 212, and the system interface circuitry 214.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 5 and 6, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 5 and 6 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 5 and 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry 816 (sometimes referred to as an ALU), a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 5 and 6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5 and 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5 and 6. As such, the FPGA circuitry 900 may be configured and/or structured to effectively instantiate some or all of the operations/functions corresponding to the machine readable instructions of the flowchart(s) of FIGS. 5 and 6 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 5 and 6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 5 and 6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 5 and 6 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 5 and 6, and/or an ASIC may be configured and/or structured to perform third operation(s)/function(s) corresponding to a third portion of the machine readable instructions represented by the flowcharts of FIGS. 5 and 6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

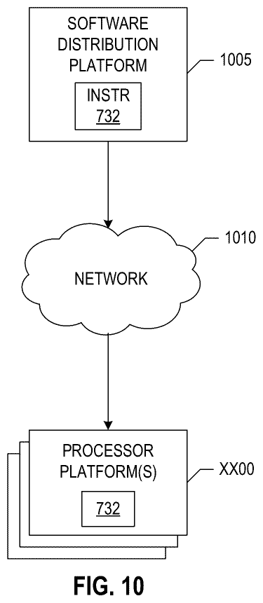

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 5 and 6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 5 and 6, may be downloaded to the example programmable circuitry platform 700, which is to execute the machine readable instructions 732 to implement the audio adjuster circuitry. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Methods and apparatus to audio adjustment based on vocal effort are disclosed herein. Further examples and combinations thereof include the following:

Example 1 includes an apparatus comprising interface circuitry, machine readable instructions, and programmable circuitry to at least one of instantiate or execute the machine readable instructions to identify a speech with a soft voice type in audio from a first user device, the speech with a soft voice type including phonation, modify the audio to generate modified audio based on the identification of the speech with a soft voice type, and output the modified audio from a second user device.

Example 2 includes the apparatus of example 1, wherein the programmable circuitry is to at least one of instantiate or execute the machine readable instructions to identify the speech with a soft voice type of the audio of the audio by accessing an output of an audio vocal effort classifier based on an input of the audio, generating a postprocessed vocal classification output by apply a moving average filter to the output of the vocal classification model, and comparing the postprocessed vocal classification output to a threshold.

Example 3 includes the apparatus of example 1, wherein the output of the audio vocal effort classifier includes a binary output corresponding to a presence of the speech with a soft voice type.

Example 4 includes the apparatus of example 1, wherein the programmable circuitry is to at least one of instantiate or execute the machine readable instructions to modify the audio by applying a preset gain to the audio.

Example 5 includes the apparatus of example 4, wherein the preset gain is approximately 8 decibels.

Example 6 includes the apparatus of example 1, wherein the programmable circuitry is to at least one of instantiate or execute the machine readable instructions to modify the audio by reducing non-speech noise in the audio.

Example 7 includes the apparatus of example 1, wherein the programmable circuitry is to at least one of instantiate or execute the machine readable instructions to modify the audio by increasing a pitch of the audio.

Example 8 includes a non-transitory machine readable storage medium comprising instructions to cause programmable circuitry to at least identify a speech with a soft voice type in audio from a first user device, the speech with a soft voice type including phonation, modify the audio to generate modified audio based on the identification of the speech with a soft voice type, and output the modified audio from a second user device.

Example 9 includes the non-transitory machine readable storage medium of example 8, wherein the instructions are to cause the programmable circuitry to access an output of an audio vocal effort classifier based on an input of the audio, generate a postprocessed vocal classification output by apply a moving average filter to the output of the vocal classification model, and compare the postprocessed vocal classification output to a threshold.

Example 10 includes the non-transitory machine readable storage medium of example 8, the output of the audio vocal effort classifier model includes a binary output corresponding to a presence of the speech with a soft voice type.

Example 11 includes the non-transitory machine readable storage medium of example 8, wherein the instructions are to cause the programmable circuitry to modify the audio by applying a preset gain to the audio.

Example 12 includes the non-transitory machine readable storage medium of example 12, wherein the preset gain is approximately 8 decibels.

Example 13 includes the non-transitory machine readable storage medium of example 8, wherein the instructions are to cause the programmable circuitry to modify the audio by reducing non-speech noise in the audio.

Example 14 includes the non-transitory machine readable storage medium of example 8, wherein the instructions are to cause the programmable circuitry to modify the audio by increasing a pitch of the audio.

Example 15 includes a method comprising identifying a speech with a soft voice type in audio from a first user device, the speech with a soft voice type including phonation, modifying the audio to generate modified audio based on the identification of the speech with a soft voice type, and outputting the modified audio from a second user device.

Example 16 includes the method of example 15, wherein the identifying the speech with a soft voice type of the audio of the audio includes accessing an output of a vocal classification model based on an input of the audio, generating a postprocessed output by apply a moving average filter to the output of the vocal classification model, and comparing the postprocessed output to a threshold.

Example 17 includes the method of example 15, wherein the output of a vocal classification model includes a binary output corresponding to a presence of the speech with a soft voice type.

Example 18 includes the method of example 15, wherein the modifying the audio includes applying a preset gain to the audio.

Example 19 includes the method of example 15, wherein the modifying the audio includes reducing non-speech noise in the audio.

Example 20 includes the method of example 15, wherein the modifying the audio includes increasing a pitch of the audio.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine readable instructions; and
programmable circuitry to at least one of instantiate or execute the machine readable instructions to:
identify speech with a soft voice type in audio from a first user device, the speech with the soft voice type including phonation;
modify the audio to generate modified audio based on the identification of the speech with the soft voice type; and
output the modified audio from a second user device.

2. The apparatus of claim 1, wherein the programmable circuitry is to at least one of instantiate or execute the machine readable instructions to identify the speech with the soft voice type of the audio of the audio by:
accessing an output of an audio vocal effort classifier based on an input of the audio;
generating a postprocessed vocal classification output by apply a moving average filter to the output of the vocal classification model; and
comparing the postprocessed vocal classification output to a threshold.

3. The apparatus of claim 2, wherein the output of the audio vocal effort classifier includes a binary output corresponding to a presence of the speech with the soft voice type.

4. The apparatus of claim 1, wherein the programmable circuitry is to at least one of instantiate or execute the machine readable instructions to modify the audio by applying a preset gain to the audio.

5. The apparatus of claim 4, wherein the preset gain is approximately 8 decibels.

6. The apparatus of claim 1, wherein the programmable circuitry is to at least one of instantiate or execute the machine readable instructions to modify the audio by reducing non-speech noise in the audio.

7. The apparatus of claim 1, wherein the programmable circuitry is to at least one of instantiate or execute the machine readable instructions to modify the audio by increasing a pitch of the audio.

8. A non-transitory machine readable storage medium comprising instructions to cause programmable circuitry to at least:
identify speech with a soft voice type in audio from a first user device, the speech with the soft voice type including phonation;
modify the audio to generate modified audio based on the identification of the speech with the soft voice type; and
output the modified audio from a second user device.

9. The non-transitory machine readable storage medium of claim 8, wherein the instructions are to cause the programmable circuitry to:
access an output of an audio vocal effort classifier based on an input of the audio;
generate a postprocessed vocal classification output by apply a moving average filter to the output of the vocal classification model; and
compare the postprocessed vocal classification output to a threshold.

10. The non-transitory machine readable storage medium of claim 9, the output of the audio vocal effort classifier model includes a binary output corresponding to a presence of the speech with the soft voice type.

11. The non-transitory machine readable storage medium of claim 8, wherein the instructions are to cause the programmable circuitry to modify the audio by applying a preset gain to the audio.

12. The non-transitory machine readable storage medium of claim 11, wherein the preset gain is approximately 8 decibels.

13. The non-transitory machine readable storage medium of claim 8, wherein the instructions are to cause the programmable circuitry to modify the audio by reducing non-speech noise in the audio.

14. The non-transitory machine readable storage medium of claim 8, wherein the instructions are to cause the programmable circuitry to modify the audio by increasing a pitch of the audio.

15. A method comprising:
identifying a speech with a soft voice type in audio from a first user device, the speech with the soft voice type including phonation;
modifying the audio to generate modified audio based on the identification of the speech with the soft voice type; and
outputting the modified audio from a second user device.

16. The method of claim 15, wherein the identifying the speech with the soft voice type of the audio of the audio includes:
accessing an output of a vocal classification model based on an input of the audio;
generating a postprocessed output by apply a moving average filter to the output of the vocal classification model; and
comparing the postprocessed output to a threshold.

17. The method of claim 15, wherein the output of a vocal classification model includes a binary output corresponding to a presence of the speech with the soft voice type.

18. The method of claim 15, wherein the modifying the audio includes applying a preset gain to the audio.

19. The method of claim 15, wherein the modifying the audio includes reducing non-speech noise in the audio.

20. The method of claim 15, wherein the modifying the audio includes increasing a pitch of the audio.
